(19) United States
(12) Patent Application Publication
(10) Pub. No.: US 2015/0048778 A1
(43) Pub. Date: Feb. 19, 2015

(54) MODULAR BATTERY CHARGING STATION AND GENERATOR

(71) Applicant: Quantum Group, Inc., Farmington, UT (US)

(72) Inventor: Bryce Davidson, Farmington, UT (US)

(73) Assignee: QUANTUM GROUP, INC., Farmington, UT (US)

(21) Appl. No.: 14/459,086

(22) Filed: Aug. 13, 2014

Related U.S. Application Data
(60) Provisional application No. 61/865,491, filed on Aug. 13, 2013.

(51) Int. Cl. H02J 7/35; H02J 7/00

(52) U.S. Cl. CPC H02J 7/355; H02J 7/0052; H02J 7/007
USPC 320/101

(57) ABSTRACT

A modular battery charging system includes a modular battery charging station and at least one modular battery within the modular battery charging station. The modular battery charging station is connected to a grid connected home solar power system. The modular battery charging station is connected between at least one solar panel and a connection to an electricity grid. The at least one solar panel powers the modular battery charging station and the modular battery is connected to the modular battery charging station. The modular battery charging station charges the modular battery and the modular battery is removable from the modular battery charging station.

### CROSS-REFERENCE TO RELATED APPLICATIONS

This application claims the benefit of U.S. Provisional Application No. 61/865,491, filed on Aug. 13, 2013, which is incorporated by reference herein in its entirety.

### BACKGROUND

Use of solar power and solar panels to generate power has increased in the past decade as technology has improved and cost has decreased. As a result many people have installed or are installing solar panels on their homes to decrease the costs of electricity. The electricity produced by the solar panels is generally either used in the home or fed into the commercial electricity grid to which the house is connected.

### SUMMARY

Embodiments of a modular battery charging system are described. In one embodiment, a modular battery charging system includes a modular battery charging station and at least one modular battery within the modular battery charging station. The modular battery charging station is connected to a grid connected home solar power system. The modular battery charging station is connected between at least one solar panel and a connection to an electricity grid. The at least one solar panel powers the modular battery charging station and the modular battery is connected to the modular battery charging station. The modular battery charging station charges the modular battery and the modular battery is removable from the modular battery charging station. Other embodiments of the system are also described.

Embodiments of a modular battery charging system are described. In one embodiment, a modular battery charging system includes a modular battery charging station including a charging unit, a battery bank, and at least one cavity. The cavity includes connections and the modular battery charging station is connected to a grid connected home solar power system. The modular battery charging station is connected between at least one solar panel and a connection to an electricity grid. The modular battery charging system further includes at least one modular battery within the modular battery charging station. The at least one solar panel powers the modular battery charging station and the modular battery charging station charges the modular battery. The modular battery is removable from the modular battery charging station.

Embodiments of a modular battery generator system are described. In one embodiment, a modular battery generator system includes a modular generator including a cavity. The cavity includes connections. The modular battery generator system further includes a modular battery. The modular battery is configured to insert into the cavity and mate with the connections of the cavity. The modular battery is removable from the modular generator. The modular battery generator system further includes an inverter and a socket. The inverter converts direct current from the modular battery to alternating current. The socket receives the alternating current from the inverter. The modular battery is recharged through use of at least one photovoltaic module attached to a house. The photovoltaic module is part of a grid-connected home solar power system. The home solar power system is connected to an electricity grid. Other embodiments of the system are also described. Embodiments of a method are readily apparent using the components of the systems as described.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts one embodiment of a house using a modular battery charging system including a modular battery charging station.

FIG. 2 depicts one embodiment of the modular battery charging station of FIG. 1.

FIGS. 3A and 3B depict different views of one embodiment of a modular battery.

FIG. 3C depicts one embodiment of a modular battery including retractable panels covering the terminals of the battery.

FIG. 4 depicts one embodiment of a modular generator using modular batteries.

FIG. 5 depicts one embodiment of an amp meter connected to a solar panel and solar generator.

FIG. 6 depicts a schematic diagram of one embodiment of a modular battery charging and generator system.

Throughout the description, similar reference numbers may be used to identify similar elements.

### DETAILED DESCRIPTION

In the following description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

While many embodiments are described herein, at least some of the described embodiments facilitate charging modular batteries with existing home solar panels connected to an electricity grid. In some embodiments, the modular batteries can be removed from the charging station or unit and placed within in a generator to utilize the power. Some embodiments allow homeowners to utilize power stored from solar panels when there is a power outage on the homeowner's power grid. Some embodiments allow a homeowner to access fully charged modular batteries at any time for use in an emergency or for convenience.

For example, during a power outage, a homeowner may access the modular battery charging station and remove one or more modular batteries. The homeowner may then use the modular batteries to power a modular generator by simply inserting the modular batteries into the generator. Additionally, a homeowner may access the modular batteries in non-emergency situations, for example, when travelling to areas without electricity access (e.g. camping). Some embodiments increase homeowner satisfaction of home solar panels as the homeowner can access and use the energy generated by their solar panels at any time. Some embodiments allow use of a portable generator without the need of a dedicated solar panel for the generator. A homeowner's existing home solar panels can be used to charge batteries and power the portable generator. Some embodiments allow faster charging of a portable generator as a house may have significantly more solar panels than a single dedicated solar panel that traditionally charges a portable solar generator.

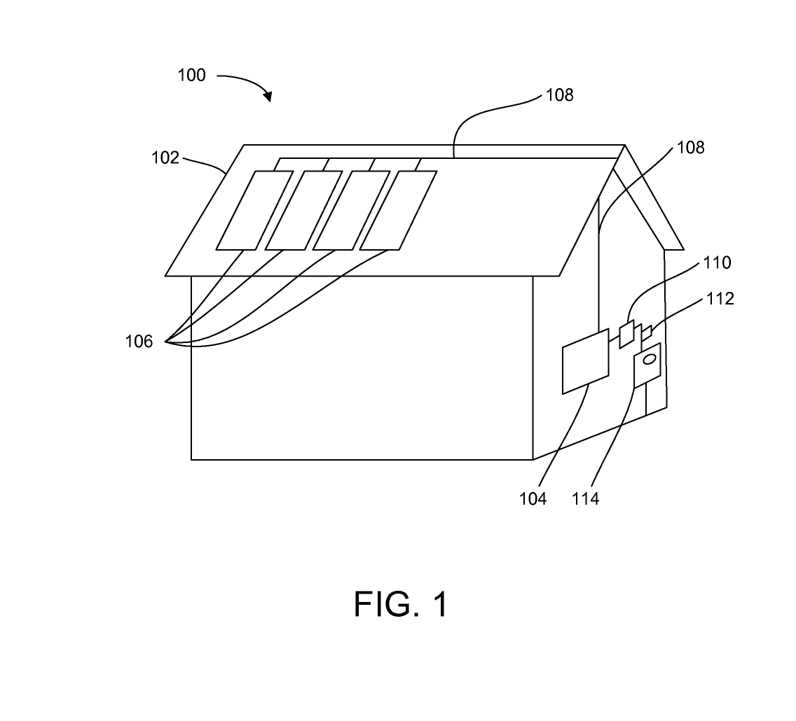

FIG. 1 depicts one embodiment of a house 102 using a modular battery charging system 100 including a modular battery charging station 104. Although the modular battery charging system 100 is shown and described with certain components and functionality, other embodiments of the modular battery charging system 100 may include fewer or more components to implement less or more functionality. Additionally, although the components of the modular battery charging system 100 are shown with a particular sequence, other embodiments of the modular battery charging system 100 may include a different sequence of components.

The illustrated modular battery charging system 100 is mounted to a house 102 and includes a modular battery charging station 104 mounted to the house 102, and solar panels 106. The illustrated modular battery charging system 100 also includes wiring 108, an inverter 110, a shutoff 112, and a meter and connection to an electricity grid 114.

The illustrated modular battery charging system 100 includes solar panels 106. The solar panels may include but are not limited to crystalline solar panels including monocrystalline panels or polycrystalline panels, thin film solar panels, amorphous panels, building integrated photovoltaics (BIPV) or solar roof shingles, or other types of solar panels that are used to produce direct current or alternating current. The illustrated solar panels 106 are electrically connected through wiring 108 to an electricity grid. The solar panels 106 may be connected in series or in parallel. One skilled in the art will recognize various types of solar panels that may be used and various configurations that may be implemented which are not outlined for the sake of brevity.

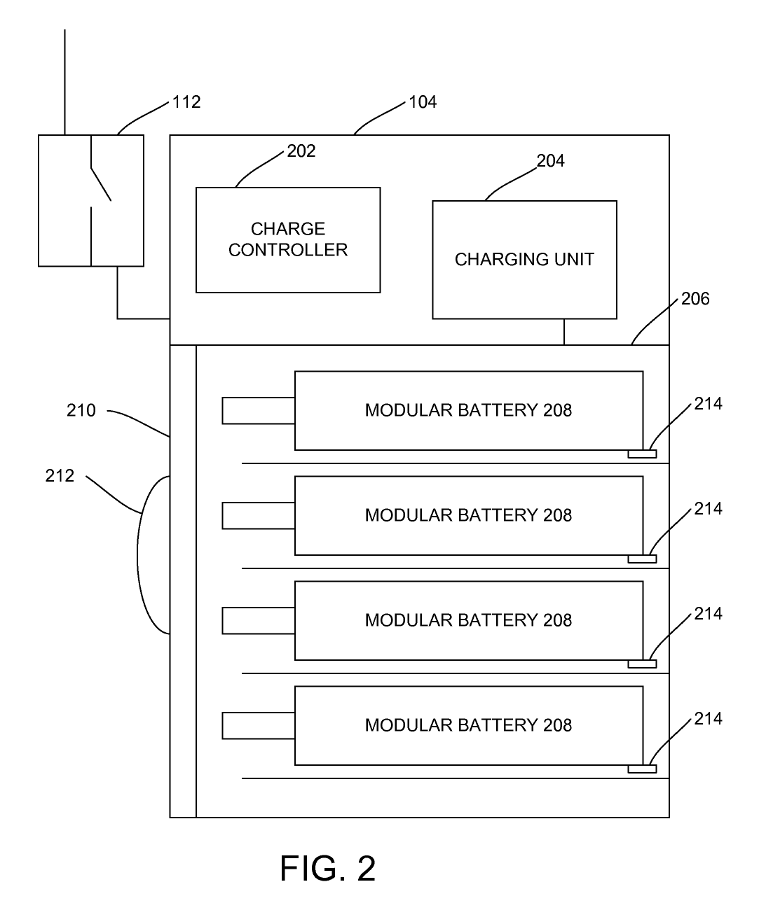

The illustrated modular battery charging system 100 includes an inverter 110. The inverter 110 converts the direct current of the solar panels 106 into alternating current that is compatible for use in the home 102 or on the electricity grid. In some embodiments, each solar panel 106 will include a micro-inverter that converts the direct current of the solar panel into alternating current. The illustrated modular battery charging system 100 includes a shutoff 112. Solar panel systems connected to an electricity grid will have a shutoff 112 to protect workers when there is a power outage. To ensure that electricity is not transferred from the solar panels 106 to the electricity grid during a power outage, a shutoff 112 is implemented. In some embodiments, the shutoff 112 is integrated with the inverter 110. For many homeowners, the shutoff is frustrating as use of the solar panels is most valuable during a power outage. The use of modular batteries within the modular battery charging station allows a homeowner to use energy stored from the solar panels during a power outage. FIG. 1 also illustrates a meter 114 and connection to an electricity grid, and a modular battery charging station 104, which is described in more detail in conjunction with FIG. 2.

FIG. 2 depicts one embodiment of the modular battery charging station 104 of FIG. 1. Although the modular battery charging station 104 is shown and described with certain components and functionality, other embodiments of the modular battery charging station 104 may include fewer or more components to implement less or more functionality.

The illustrated modular battery charging station 104 shows a shutoff 112. In some embodiments the shutoff 112, inverter 110, and the charging station 104 are integrated into one single unit. In some embodiments, these components are separate. The illustrated modular battery charging station 104 includes a charge controller 202, a charging unit 204, a battery bank 206, modular batteries 208, a side access panel 210, and a handle 212.

Some embodiments include a charge controller 202. In some embodiments, the charge controller 202 is external to the modular battery charging station 104. In some embodiments, the charge controller 202 is internal to the modular battery charging station 104. In some embodiments, the charge controller 202 is integrated into the charging unit 204. The charge controller or charge regulator 202 regulates the voltage and/or current to keep the batteries 208 from overcharging. In some embodiments, the charge controller may be but is not limited to a 1 or 2 stage control, a 3 stage control, a pulse width modulation (PWM), a maximum power point tracking control (MPPT), or another type of controller capable of regulating the voltage and/or current from the solar panels 106.

The illustrated modular battery charging station 104 includes a charging unit 204 that facilitates the charging of the modular batteries 208. In some embodiments, the charging unit 204 may integrate the functionality of the charge controller 202 and may utilize a rectifier or inverter as necessary. The charging unit 204 supplies the necessary current to the battery bank 206 to charge the modular batteries 208.

The battery bank 206 may include any combination of modular batteries 208 and any number of modular batteries. The illustrated modular battery charging station 104 includes four batteries 208. In some embodiments, the battery bank 206 allows removal of less than all the modular batteries 208 within the battery bank 206. The modular battery charging station 104 may continue to charge the remaining modular batteries 208. The configuration of the modular battery charging station 104 will depend greatly upon the type of modular batteries 208 that are used. The modular battery charging station 104 may be designed for easy and repeated insertion and removal of the modular batteries 208 as needed. In some embodiments, each modular battery 208 fits into a cavity within the battery bank 206 where the cavity shape and dimensions are equivalent to the shape and outer dimensions of the modular battery 208. In some embodiments, the inner dimensions of the perimeter of the cavity are equal to the outer dimensions of the perimeter of the modular battery 208.

In some embodiments, the charging unit 204 or charging controller 202 will continue to charge any modular batteries 208 within the cavities of the battery bank 206 while some of the cavities are empty. For example, a battery bank 206 may contain four cavities for four modular batteries 208. Only one modular battery 208 need be inserted into one of the cavities for the modular battery 208 to charge. The homeowner may remove two of four modular batteries 208 while the other two modular batteries 208 continue to charge.

The battery bank 206 may further include includes connections 214 to connect with the terminals of the modular batteries 208 to allow the charging and recharging of the modular batteries 208.

In some embodiments, the modular batteries 208 within the battery bank 206 may be different type of rechargeable batteries or be mixed chemistries. For example, the battery bank 206 may be able to charge 3 lithium batteries and 1 absorbed glass mat (AGM) battery, or 2 AGM batteries and 2 lithium batteries, or another combination.

The illustrated modular battery charging station 104 includes a panel 210 with a handle 212 for easy access to the modular batteries 208 within the charging station 104. A homeowner may open or remove the panel 210 to access and remove and/or insert the modular batteries 208.

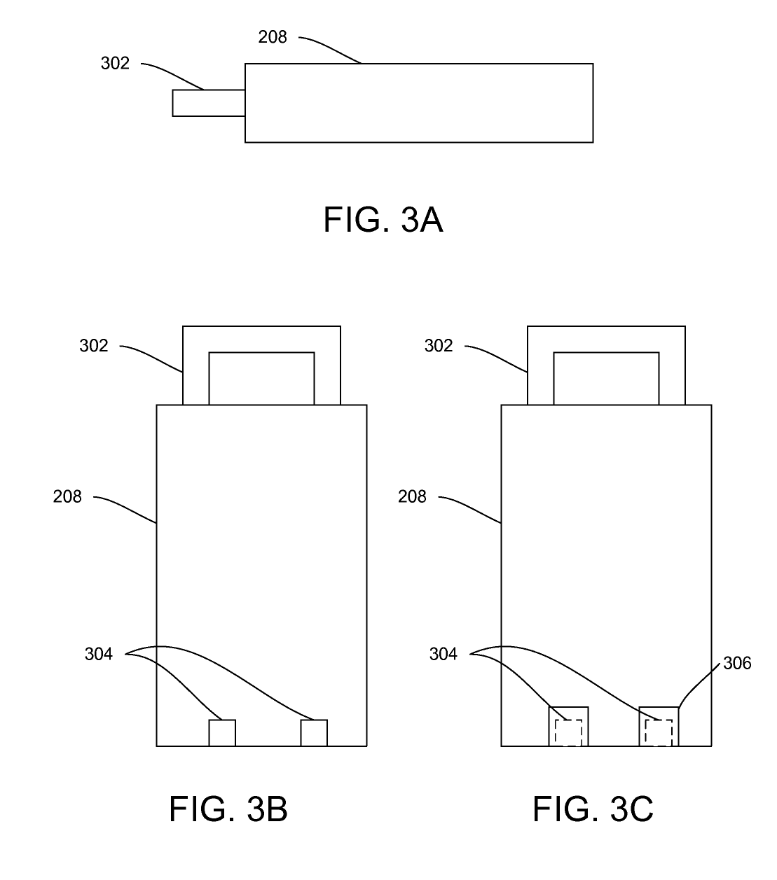

FIGS. 3A and 3B depict different views of one embodiment of a modular battery 208. FIG. 3A depicts a side view as the modular battery 208 is horizontal. FIG. 3B depicts a front view as the modular battery 208 is vertical. The modular battery 208 includes a handle 302 to allow easy removal and transport of the modular battery 208. In some embodiments, the handle 302 may fold, collapse or retract into the battery 208 when inserted into the cavity of the battery bank 206. The illustrated modular battery 208 of FIG. 3B includes terminals 304 for connection of the modular batteries 208 within the modular battery charging station 104 or within a modular battery generator. The modular batteries 208 are designed for easy removal from the charging station 104. In some embodiments, the terminals 304 are only exposed while the modular battery 208 is inserted within the charging station 104 or within a modular battery generator. For example, a retractable panel may cover the terminals 304 while the modular battery is not being charged. As a homeowner inserts the modular battery 208 into the battery bank 206, the panel retracts or otherwise moves to expose the terminals 304 for charging. The panel may also retract or otherwise move to expose the terminals 304 when inserted into a modular generator.

FIG. 3C depicts one embodiment of a modular battery including retractable panels covering the terminals of the battery. The illustrated embodiment depicts retractable panels 306 that cover the terminals 304. The panels 306 may cover the terminals whenever the modular battery 208 is removed from the modular battery charging station 104 or the modular generator. When inserted into either the modular battery charging station 104 or the modular generator, the panels 306 may retract to expose the terminals 304 for charging or discharge. In some embodiments, the retractable panels 306 are made of any insulating material such that the charge across the modular battery terminals 304 does not inadvertently dissipate or discharge.

The modular batteries 208 may be secondary or rechargeable batteries. The modular batteries 208 may be but are not limited to valve regulated lead-acid (VLRA) batteries, gel batteries, absorbed glass mat (AGM) batteries, lithium batteries, or any other type of rechargeable batteries.

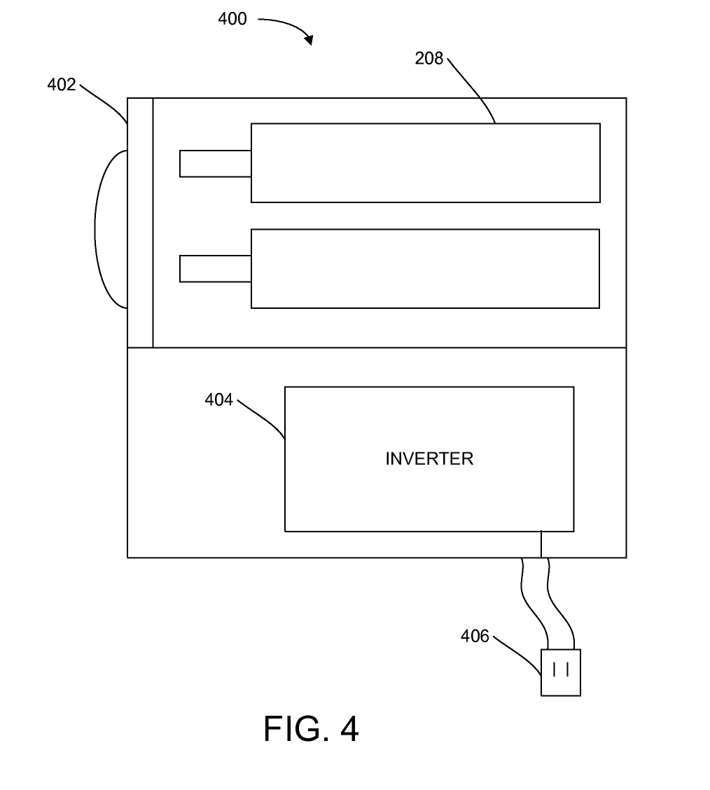

FIG. 4 depicts one embodiment of a modular generator 400 using modular batteries 208. Typically, solar generators require an investment in a solar panel dedicated for the solar generator. The solar generator is charged by connecting the solar panel to the generator and charging the generator. In such a situation, the battery is not removable from the generator, at least without damaging the generator. A modular generator 400 may utilize modular batteries 208, thus removing the need for a dedicated solar panel for the generator. A homeowner may simply remove a charged modular battery 208 from the modular battery charging station 104 and insert the modular battery 208 into the modular generator 400. Investing in more than one dedicated solar panel for a solar generator is costly, whereas homeowners typically install many solar panels on their roof. A modular generator 400 that utilizes modular batteries 208 from a modular battery charging system 100 may fully charge a solar generator faster than through the use of a single dedicated solar panel. The illustrated modular generator 400 includes a panel 402 for insertion of the modular batteries 208, an inverter 404 to convert the direct current into alternating current, and at least one outlet 406.

In some embodiments, the modular generator 400 includes a cavity into which the modular batteries 208 are inserted. In some embodiments, each modular battery 208 fits into a cavity within the modular generator 400 where the cavity shape and dimensions are equivalent to the shape and outer dimensions of the modular battery 208. In some embodiments, the inner dimensions of the perimeter of the cavity are equal to the outer dimensions of the perimeter of the modular battery 208. In some embodiments, more than one modular battery 208 may be inserted into the modular generator 400. In some embodiments, each modular battery 208 within the generator 400 may a different type of battery. For example, there may be 2 lithium batteries and 2 AGM batteries, or another combination. In some embodiments, the generator is hot swappable. That is, the modular generator 400 will continue to function while one of the modular batteries 208 is removed and/or replaced with another modular battery 208.

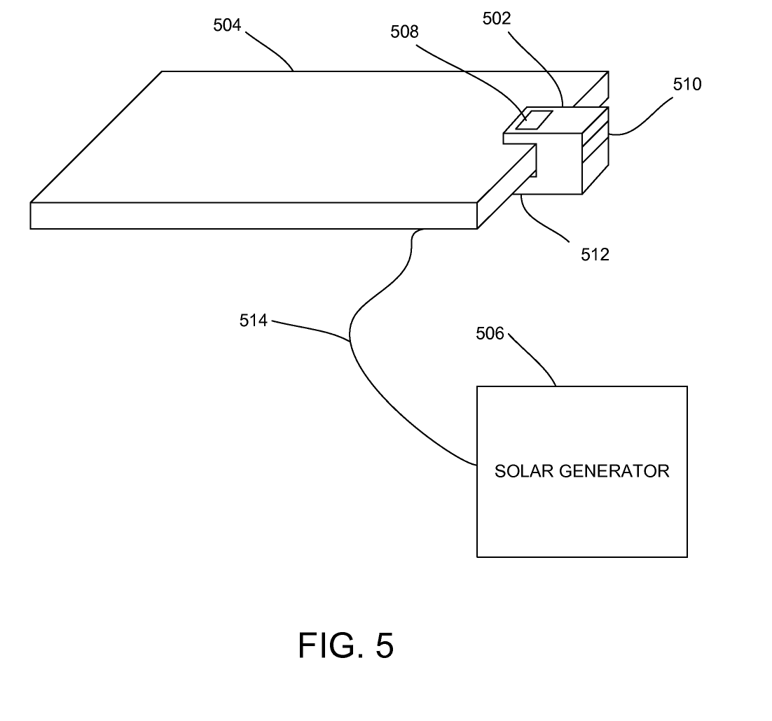

FIG. 5 depicts one embodiment of an amp meter 502 connected to a solar panel 504 and solar generator 506. The purpose of the amp meter 502 is to determine the optimal direction and orientation of the solar panel 504. The orientation and direction of a solar panel 504 is important to the overall performance of the solar panel 504. The angle and direction of the sunlight on the solar panel affect the overall output of the solar panel. The optimal direction of solar panels in the direction and orientation that captures the most sunlight. As the sun moves during the day the optimal direction and orientation will change as well. Additionally, the time of year affects the direction and orientation as well. These variations throughout the day and year can greatly reduce the efficiency of a solar panel and increase the time needed to charge a solar generator. As such many people will try to locate the one optimal direction and orientation that will produce the most energy. Alternatively, consumers may utilize tracking panels that track the sun throughout the day as they can harvest more energy quickly. However, tracking panels can be expensive, sometimes prohibitively, and may not justify the increase in efficiency. FIG. 5 illustrates a low cost alternative that allows a consumer to better orient and direct their solar panel without the expense of a tracking panel.

By attaching an amp meter 502 to an existing solar panel 504 and solar generator 506, a user may determine the optimal orientation and direction of the solar panel 504. The illustrated amp meter 502 includes a photovoltaic (PV) cell 508. The attached amp meter 502 will attach such that the PV cell 508 faces the same direction as the PV cells of the solar panel 504. The illustrated amp meter 502 includes a display 510 which will indicate the amps produced. The illustrated amp meter 502 is secured to the solar panel 504 through a clamp 512. The solar panel 504 is connected to the solar generator 506 through wiring 514. By attaching the amp meter 502 to the solar panel 504, a user may move and orient the solar panel 504 until the user determines the direction and orientation that produces the most energy. The user can continue this process as needed and greatly reduce the time to charge the solar generator 506.

Those skilled in the art will recognize various ways to measure the electrical properties, including other properties besides amps, such that a user may determine the optimal orientation and direction of a solar panel 504 in order to produce the most energy. Additionally, those skilled in the art will recognize that a combination of electrical properties may be measured to determine the optimal orientation and direction of a solar panel 504 in order to produce the most energy. In some embodiments the display may be located on the solar generator 506 or another location including the wiring. In some embodiments the amp meter 502 may directly measure the solar panel 504, or the wiring 514, or on the solar generator 506.

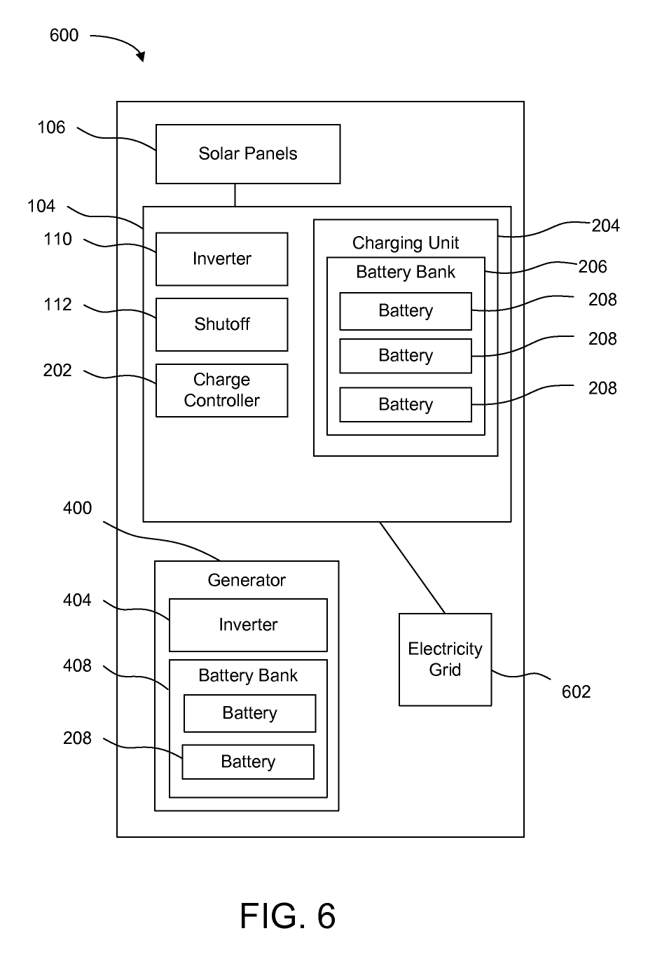

FIG. 6 depicts a schematic diagram of one embodiment of a modular battery charging and generator system 600. Although the modular battery charging and generator system 600 is shown and described with certain components and functionality, other embodiments of the modular battery charging and generator system 600 may include fewer or more components to implement less or more functionality. Additionally, although the components of the modular battery charging and generator system 600 are shown with a particular sequence, other embodiments of the modular battery charging and generator system 600 may include a different sequence of components.

The illustrated modular battery charging and generator system 600 includes solar panels 106, a modular battery charging station 104, and a portable modular generator 400. The illustrated modular battery charging and generator system 600 also depicts the electricity grid 602.

In the illustrated embodiment, the solar panels 106 are connected to the modular battery charging station 104 to allow for the modular battery charging station 104 to harvest the electricity created by the solar panels 106. The electricity of the solar panels 106 is adequately converted to power the charging unit 204 and charge and recharge the batteries 208 within the battery bank 206. Various inverters and rectifiers may be present within the system 600 to adequately convert between AC and DC and between DC and AC as needed. These inverters and rectifiers may be placed anywhere within the system and may be on the solar panels 106, in series between the solar panels 106 and the charging station 104, within the charging station 104 or between the charging station 104 and the electricity grid 602. In addition, a shutoff 112 may be located within the system 600.

The charging station 104 may further include a charge controller 202. In some embodiments, the charge controller 202 is external to the modular battery charging station 104. In some embodiments, the charge controller 202 is internal to the modular battery charging station 104. In some embodiments, the charge controller 202 is integrated into the charging unit 204. The charge controller 202 regulates the voltage and/or current to keep the batteries 208 from overcharging. In some embodiments, the charge controller 202 is part of the charging unit 204. The batteries 208 are interchangeable between the charging station 104 and the portable modular generator 400. In this way, the batteries 208 may be charged using the solar panels 106 already mounted on a house. The batteries 208 may be recharged and stored with a full charge ready to be used at a time of need or convenience. In the case of a power outage, the charged batteries 208 may be used to power the generator 400 and power any household appliances and electronics. In another situation, the batteries 208 may be removed and taken with the portable generator 400 to any location without electrical connection and allows the user to harvest the energy created by home solar panels in distant locations.

In some embodiments, the system 600 is able to convert existing home solar power systems by inserting the modular battery charging station 104 within the connection between the existing solar panels of a house and the electricity grid 602. This allows homeowners with existing home solar power systems to enjoy the benefits of power generation during times when the electricity grid 602 is down. Additionally, a generator 400 with a battery bank 408 compatible with the batteries 208 charged by the charging station 104 may allow a user to run a generator without the use of gas. The generator 400 may be powered by clean solar energy through the storing, charging, and dissipation of the batteries 208.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A modular battery charging system, the modular battery charging system comprising:
a modular battery charging station, wherein the modular battery charging station is connected to a grid connected home solar power system;
at least one modular battery within the modular battery charging station;
wherein the modular battery charging station is connected between at least one solar panel and a connection to an electricity grid, wherein the at least one solar panel powers the modular battery charging station; and
wherein the modular battery is connected to the modular battery charging station, wherein the modular battery charging station charges the modular battery, wherein the modular battery is removable from the modular battery charging station.

2. The modular battery charging system of claim 1, wherein the modular battery charging system further comprises:
a portable modular generator, wherein the portable modular generator is configured to receive the modular battery, and wherein the modular generator is powered by the modular battery.

3. The modular battery charging system of claim 1, wherein the modular battery comprises an absorbed glass mat battery, wherein the modular battery is rechargeable, wherein the modular battery recharges when placed within the modular battery charging system.

4. The modular battery charging system of claim 1, wherein the modular battery comprises a lithium battery, wherein the modular battery is rechargeable, wherein the modular battery recharges when placed within the modular battery charging system.

5. The modular battery charging system of claim 1, wherein the modular battery charging system further comprises:
a charge controller external to the modular battery charging station, wherein the charge controller regulates the voltage or current.

6. The modular battery charging system of claim 1, wherein the modular battery charging system further comprises:
a charge controller integrated within the modular battery charging station, wherein the charge controller regulates the voltage or current supplied to the modular battery when recharging.

7. The modular battery charging system of claim 1, wherein the modular battery charging station further comprises:
a charging unit, wherein the charging unit supplies current from the solar panel to charge the modular battery.

8. The modular battery charging system of claim 1, wherein the modular battery charging station further comprises:
a battery bank, wherein the battery bank comprises the modular battery and a second modular battery, wherein the modular battery and the second modular battery are separately removable from the modular battery charging station, and wherein the modular battery charging station is configured to charge the second modular battery upon removal of the modular battery.

9. The modular battery charging system of claim 1, wherein the modular battery charging station further comprises:
a battery bank, wherein the battery bank comprises the modular battery and a second modular battery, wherein the modular battery and the second modular battery are separately removable from the modular battery charging station, and wherein each modular battery fits within a separate cavity within the modular battery charging station.

10. The modular battery charging system of claim 1, wherein the modular battery comprises retractable panels that cover terminals of the modular battery when the battery is removed from the modular battery charging station, and wherein the panels retract when the modular battery is inserted into the modular battery charging station.

11. The modular battery charging system of claim 1, wherein the modular battery charging system further comprises:
a shutoff, wherein the shutoff is configured to disconnect the solar panel from the electricity grid, and wherein the shutoff is between the modular battery charging stations and the electricity grid.

12. The modular battery charging system of claim 1, wherein the modular battery charging station further comprises:
an inverter integrated into the modular battery charging station, wherein the inverter converts direct current into alternating current;
a shutoff integrated into the modular battery charging station, wherein the shutoff is configured to disconnect the modular battery charging station from the electricity grid.

13. The modular battery charging system of claim 12, wherein the modular battery charging station further comprises:
a charge controller integrated into the modular battery charging station, wherein the charge controller regulates the voltage or current supplied to the modular battery when recharging.

14. A modular battery charging system, the modular battery charging system comprising:
a modular battery charging station comprising a charging unit, a battery bank, and at least one cavity, the cavity comprising connections, wherein the modular battery charging station is connected to a grid connected home solar power system, wherein the modular battery charging station is connected between at least one solar panel and a connection to an electricity grid;
at least one modular battery within the modular battery charging station, wherein the at least one solar panel powers the modular battery charging station; wherein the modular battery charging station charges the modular battery, and wherein the modular battery is removable from the modular battery charging station.

15. The modular battery charging system of claim 14, wherein the battery bank comprises the modular battery and a second modular battery, wherein the modular battery and the second modular battery are separately removable from the modular battery charging station, and wherein each modular battery fits within a separate cavity within the modular battery charging station.

16. The modular battery charging system of claim 14, wherein the charging unit supplies current from the solar panel to charge the modular battery, and wherein the battery bank comprises the modular battery and a second modular battery, wherein the modular battery and the second modular battery are separately removable from the modular battery charging station, and wherein each modular battery fits within a separate cavity within the modular battery charging station.

17. A modular battery generator system, the modular battery generator system comprising:
a modular generator comprising a cavity, wherein the cavity comprises connections;
a modular battery, wherein the modular battery is configured to insert into the cavity and mate with the connections of the cavity, wherein the modular battery is removable from the modular generator;
an inverter, wherein the inverter converts direct current from the modular battery to alternating current;
a socket, wherein the socket receives the alternating current from the inverter; and
wherein the modular battery is recharged through use of at least one photovoltaic module attached to a house, wherein the photovoltaic module is part of a grid-connected home solar power system, wherein the home solar power system is connected to an electricity grid.

18. The modular battery generator system of claim 17, the modular battery generator system further comprising:
a modular battery charging station to recharge the modular battery, wherein the modular battery charging station is mounted to the house, wherein the modular battery charging station is connected between the photovoltaic module attached to the house and the electricity grid.

19. The modular battery generator system of claim 17, wherein the modular battery comprises retractable panels that cover terminals of the modular battery when the battery is removed from the modular generator, and wherein the panels retract when the modular battery is inserted into the modular generator.

20. The modular battery generator system of claim 17, wherein the modular battery comprises a lithium battery, wherein the modular battery is rechargeable, wherein the modular battery recharges when placed within the modular battery charging system.
